(19) United States
(12) Patent Application Publication
(10) Pub. No.: US 2008/0294974 A1
(43) Pub. Date: Nov. 27, 2008

(54) WEBPAGE HISTORY VIEW

(75) Inventors: Mikko Nurmi, Tampere (FI); Antti Huupponen, Cambridge, MA (US)

Correspondence Address: FOLEY & LARDNER LLP, P.O. BOX 80278, SAN DIEGO, CA, 92138-0278, US

(73) Assignee: Nokia Corporation

(21) Appl. No.: 11/753,518

(22) Filed: May 24, 2007

(51) Int. Cl. G06F 17/00; G06F 15/00

(52) U.S. Cl. 715/204; 715/277; 715/234

(57) ABSTRACT

A system and method of selecting a web page from a plurality of web pages, wherein the plurality of web pages are represented using a plurality of thumbnails is provided. In addition, the plurality of web pages can comprise previously visited web pages and previewed web pages. The system and method further provides a visual indicator that is either displayed by default upon the selection of the web page or is drawn by a user. The visual indicator substantially encompasses a desired portion of the selected web page for initial viewing upon loading or re-loading of the selected web page. Alternatively, the visual indicator can be positioned so that at a predetermined proximity to a desired portion of the web page, the desired portion of the web page is focused on for initial viewing. Remaining portions of the selected web page not encompassed by the visual indicator are not initially displayed.

### FIELD OF THE INVENTION

The present invention relates generally to the viewing and navigation of digital visual content. More particularly, the present invention relates to the viewing of a specific portion of digital visual content on a small device screen.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Viewing web content on electronic devices can be difficult because, in many instances, only a portion of an entire web page is shown at a given moment. This makes the task of locating specific information on the web page difficult, even if a user knows roughly where specific information is located in the content. Due to the web page content being larger than the screen, the user is forced to scroll around the web page document, hoping to find the correct portion of the content. Also, the context of information visible on the screen at any given moment can also be unclear due to the surrounding areas in the document not being visible to the user.

With a conventional mobile browser implemented, for example, on a mobile device, a user can view pages that the user has already visited or browsed beforehand. In addition, the user can view a “next page” to be visited or browsed, for example, when the user wishes to return to a page that he or she previously moved back from. Such pages can be accessed via back and forward buttons in a conventional personal computer (PC)-based web browser. In order to aid the user in determining which web page he or she wants to browse back to or forward to, conventional mobile browsers can also display, generally using a “thumbnail” view, each web page which the user can move back to or forward to. When a desired web page is seen being represented in the thumbnail view, the user can select that particular thumbnail and the desired web page is re-loaded, for example. Often, the thumbnail views are displayed in a “rotating” view format, where a user can scroll through available thumbnail representations of the web pages as if he or she were flipping through a Rolodex™-style organizer. However, the user still cannot select a desired portion of the web page to be displayed when the web page is loaded.

FIG. 1 shows an example of a display visible with a conventional mobile browser. A small screen display 100 is shown having implemented therewith a conventional mobile browser for browsing digital content such as web pages. A previously visited web page can be represented by a back thumbnail 110 to which a user can move back to by instructing the mobile browser to move backwards in the direction of a back arrow 140. A next web page can be represented by a forward thumbnail 130 to which a user can move forward to by similarly instructing the mobile browser to move forward in the direction of a forward arrow 150.

In other conventional mobile browsers, a web page can be loaded upon moving back or forward to that web page so that a portion of the web page that was visible when the user left the page, i.e., stopped browsing, is displayed when the user moves back or forward to the same web page again. However, it is common for users to return to a web page, for example, to browse a different portion of the web page. That is, the user does not always want to view the same portion of the web page again. Therefore, there remains a need for a mobile web browsing feature that allows a user to conveniently and/or visually select a portion of a web page that is to be displayed on a small device screen. Furthermore, there remains a need for such a mobile web browsing feature that can be provided in conjunction with previously and to-be-viewed web pages.

In addition, during a browsing session using a small device screen, certain conventional mobile browsers allow for the rendering or adjusting of content, e.g., text to fit the confines of the small device screen. For example, to ease the reading of text in a web page, some conventional mobile browsers render blocks of text to be currently read so that the text is not displayed past the width limitations of the small device screen. However, it then becomes possible for a user to scroll past the width limitations of the small screen device, effectively negating the rendering or adjusting of the text that is fit within the small device screen. Furthermore, conventional mobile browsers provide “jump-to-text” functionality, where during a browsing session, a displayed portion of a web page is focused on textual content. Still other conventional mobile browsers provide a simple zooming feature, yet provide no recognition or intelligence with regard to displaying or otherwise conveniently rendering the zoomed in portion of the web page beyond the original/intended layout of the web page. In addition, such conventional mobile browsers cannot be conveniently operated in conjunction with, for example, those applications and/or features that provide the ability to return or go forward to previously viewed web pages, as described above.

Certain display-based applications provide a “pull-in” feature that automatically positions a cursor to a relevant position on a map, such as U.S. Pat. No. 6,904,338 to Weimper, although an identified relevant position is not saved or otherwise maintained. Furthermore, other browser-based applications, such as U.S. Patent Publication No. 2002/0075333 to Dutta et al. describe a method of changing a focus point based upon the proximity of a cursor to a selectable item. However, there remains a need for “jump-to” functionality, where other types of content can be focused on in a mobile browser and/or “mini-mapping” application operating within the physical display constraints of a small device screen, where points of interest are not limited to merely locations on a map, or to selectable objects.

### SUMMARY OF THE INVENTION

The various embodiments of the present invention provide a system and method of selecting a web page from a plurality of web pages, wherein the plurality of web pages are represented using a plurality of thumbnails. In addition, the plurality of web pages can comprise previously visited web pages. Certain embodiments of the present invention further provide a visual indicator that is either displayed by default upon the selection of the web page or is drawn by a user. According to other embodiments of the present invention, a visual indicator is generated by a computer, for example, looking at a user's behavior and/or defining areas that may be of relevance, e.g., text or pictures. The visual indicator substantially encompasses a desired portion of the selected web page for initial viewing upon re-loading of the selected web page. Remaining portions of the selected web page not encompassed by the visual indicator are not initially displayed. After the initial display of the desired portion, the user is able to navigate the entire web page as needed. Both touch screen and non-touch screen devices can utilize the various embodiments of the present invention. In addition, the features and functionality provided by the various embodiments of the present invention are not limited to use during web page history viewing, but during browsing of actual documents and web pages. Furthermore, different types of content can be focused upon for viewing and/or initial display to the user, where the different types of content can be identified using a plurality of methods including predictive and/or proximity-based intelligence.

With the various embodiments of the present invention, current mobile web browsers can be improved in terms of usability and user-convenience. A user is able to indicate a portion of the selected web page for initial viewing even before the web page is loaded, thus saving the user from the added effort of re-navigating a fully-loaded web page to arrive at the desired portion of the web page. In addition, current navigational techniques can be used to implement the various embodiments of the present invention, making integration of the various embodiments of the present invention into existing mobile web browsers both seamless and convenient. Furthermore, a user's overall browsing experience is made more convenient and user-friendly, for example, by requiring less specific navigational instructions and key actuation.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a conventional mobile browser web page display;

FIG. 2 is an overview diagram of a system within which the present invention may be implemented;

FIG. 3 is a perspective view of a mobile telephone that can be used in the implementation of the present invention;

FIG. 4 is a schematic representation of the telephone circuitry of the mobile telephone of FIG. 3;

FIG. 5A shows a webpage view history displayed in accordance with one aspect of the various embodiments of the present invention;

FIG. 5B shows a webpage view history displayed in accordance with another aspect of the various embodiments of the present invention;

FIG. 5C shows a webpage view history displayed in accordance with another aspect of the various embodiments of the present invention; and

FIG. 6 shows a flow chart illustrating exemplary operations executed in accordance with the various embodiments of the present invention.

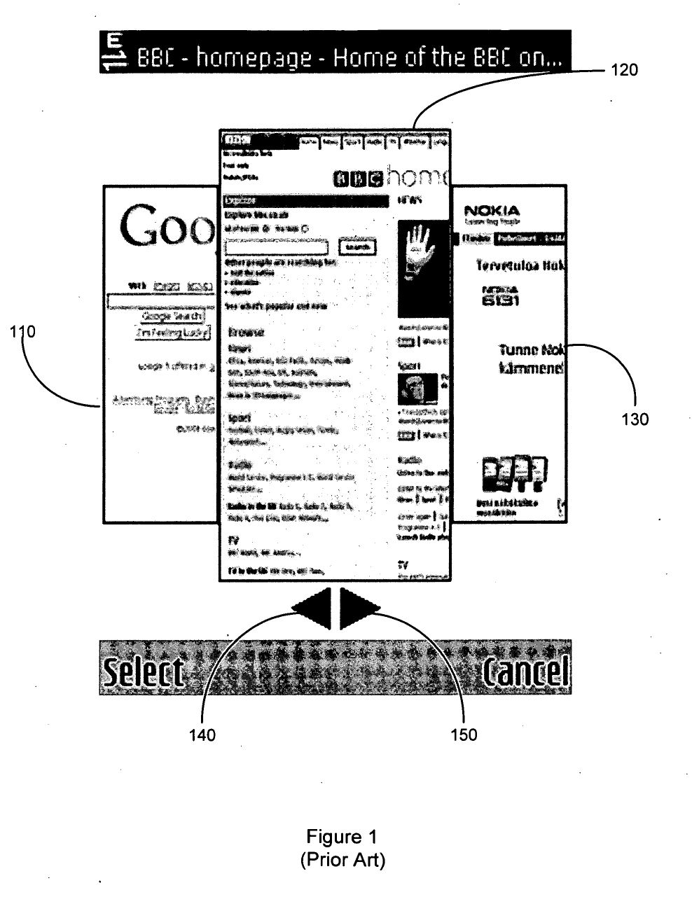

### DETAILED DESCRIPTION OF THE PREFERRED EMBODIMENTS

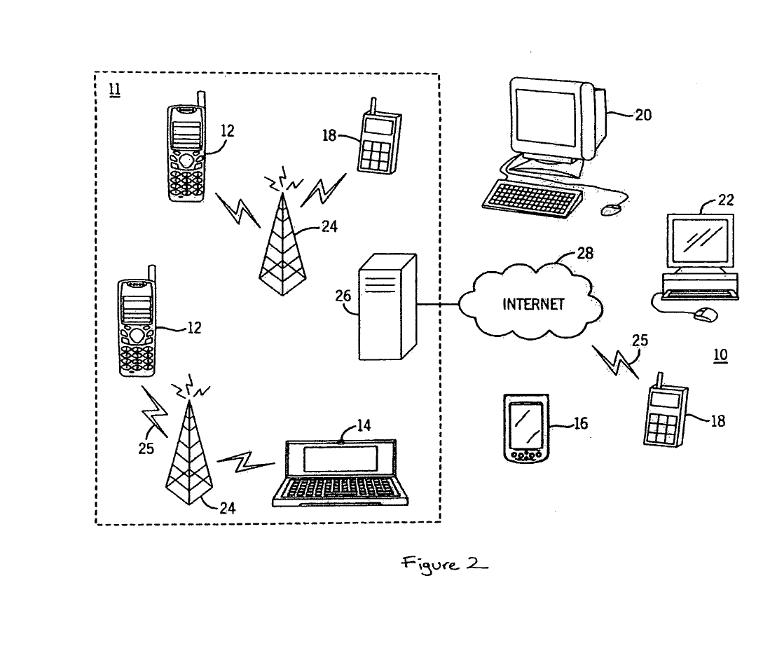

FIG. 2 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 2 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Wideband Code Division Multiple Access (WCDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

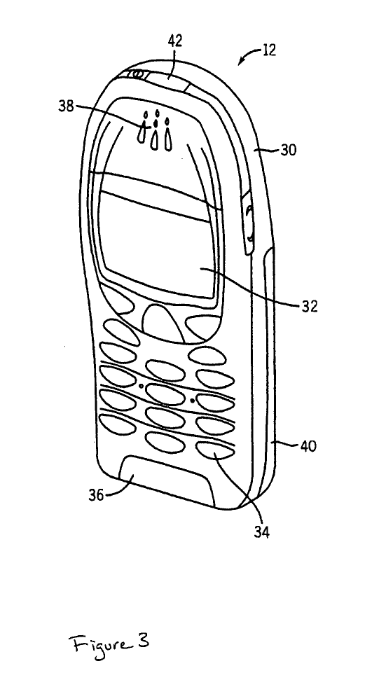

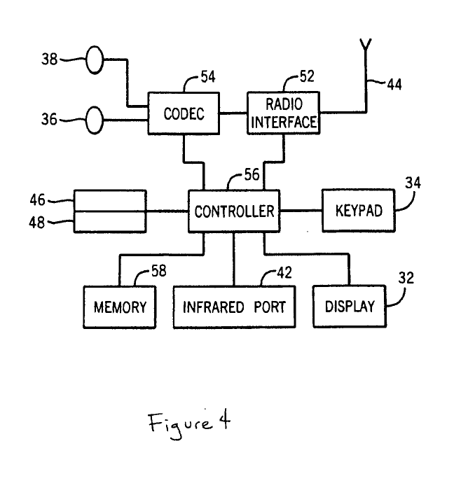

FIGS. 3 and 4 show one representative mobile device 12 within which the present invention may be implemented. It should be understood, however, that the present invention is not intended to be limited to one particular type of mobile telephone or other electronic device. The mobile device 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various embodiments of the present invention provide a system and method of selecting a desired portion of digital content, such as a web page, to be displayed upon a user moving back to or forward to the web page. The desired portion of the web page is displayed first to the user upon loading or re-loading of the web page, where loading or re-loading comprises accessing a Uniform Resource Locator (URL) of the web page and processing the URL to display the web page. Additionally, the web page may be stored in a local memory and/or storage unit, such as a local cache. Alternatively, the web page may be loaded from a remote server or a proxy server. Such a feature can be fully realized with software implementation in or in conjunction with other software applications, such as mobile web browsers, including the Nokia Open Source Software (OSS) series of web browser applications utilized in S60 devices. The term “S60” refers to a mobile device platform that uses Symbian Operating System (OS). The S60 platform comprises one or more suites of libraries and applications regarding telephony, personal information manager (PIM) tools, and various multimedia players. It is intended for implementation in, but not limited to, more modern mobile devices having increased resolution displays and more fully-featured application sets.

As described above, the various embodiments of the present invention give a user the ability to select a portion of a web page that is to be displayed first when a user moves to the web page. Moving to the web page can encompass the user choosing to move back to a previously viewed or visited web page. Moving to the web page can also encompass the user choosing to move forward to a previously viewed or visited web page, e.g., a web page that the user was viewing from which the user previously moved back to a currently viewed web page, or simply any other previously viewed web page. It should be noted that in moving to a web page, the web page need not be a previously viewed or visited web page. For example, web pages can contain hyperlinks to other web pages. When a preview of a hyperlinked web page is displayed to a user within a mobile web browser, the various embodiments of the present invention allow the user to select a portion of the hyperlinked web page for display upon actual loading of the hyperlinked web page. Furthermore, the preview could be applicable to any new web page that is to be loaded. Therefore, the preview is provided regardless of whether the new web page is determined to be a hyperlink or an entirely new web page to be viewed as a result of the user entering a new URL address.

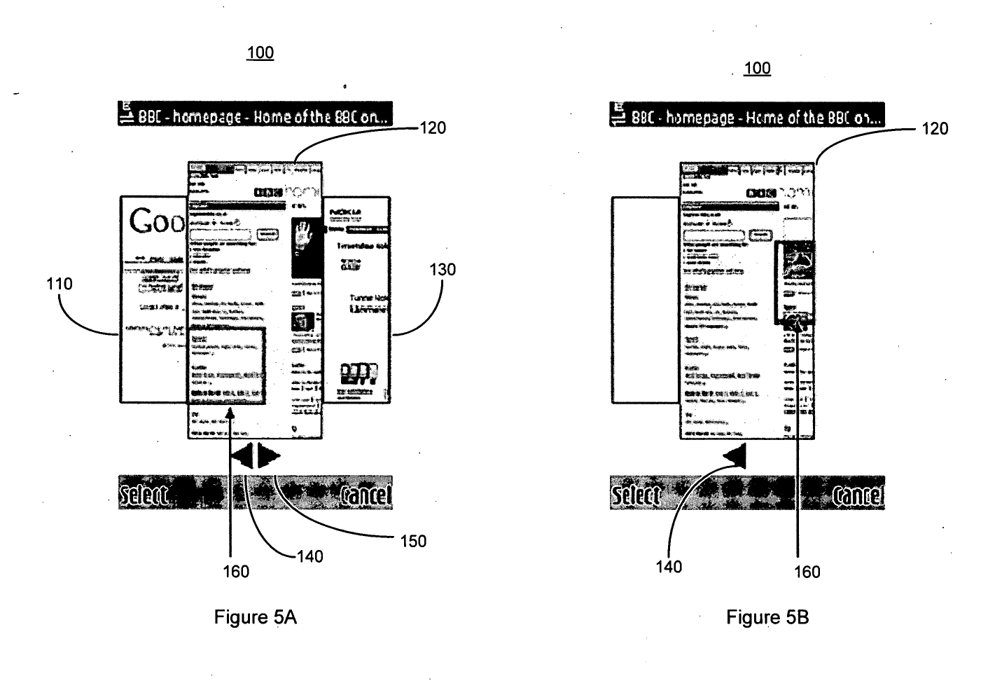

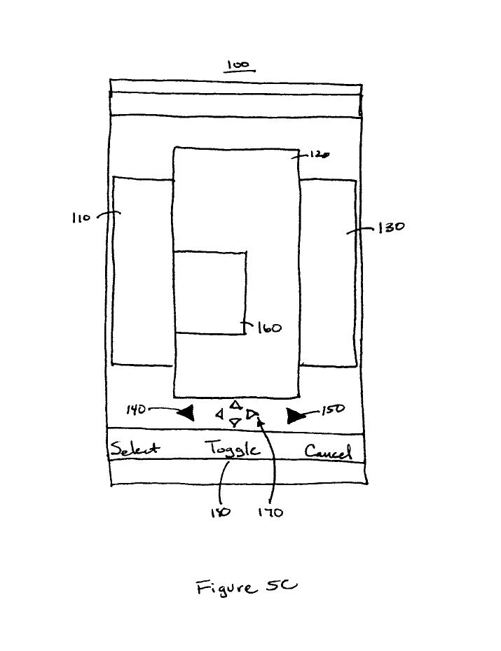

FIG. 5A illustrates a mobile web browser operating in accordance with the various embodiments of the present invention. A web page history view is displayed in a small screen display 100. The web page history view includes a previously viewed web page that a user can move back to, where the previously viewed web page is represented by a back thumbnail 110. A thumbnail refers to a miniaturized version or display of content, in this case, a previously viewed web page, which previews the content to the user. A forward thumbnail 130 is displayed, where the forward thumbnail 130 represents another web page that the user can move forward to. A current thumbnail 120 represents a desired web page that the user wishes to move back or forward to. It should be understood that the any of the thumbnails 110, 120, and/or 130 can also be used to present a miniaturized view or preview of a plurality of web pages instead of merely one previously viewed web page, for example. In addition, it should be noted that when the current thumbnail 120 has been selected by a user, the back thumbnail 110 and the forward thumbnail 130 can either be taken off of the small screen display 100 or can remain as a background image(s). Alternatively, the current thumbnail 120 can be enlarged to effectively take precedence over the back thumbnail 110 and the forward thumbnail 130. Furthermore, a URL associated with a web page represented by the current thumbnail 120 and/or any other accessible and relevant information can be displayed as a background.

Graphical indicators 140 and 150 are also shown in the small screen display 100. In the embodiment shown in FIG. 5A, the graphical indicators 140 and 150 take the form of directional arrows which indicate directions that the user can move through, for example, previously viewed web pages. For example, a back arrow 140 indicates to the user that he or she can move back to a previously viewed web page, such as that represented by the back thumbnail 110. A forward arrow 150 indicates to the user that he or she can move forward to a previously viewed web page, such as that represented by the forward thumbnail 130.

According to one embodiment of the present invention, in order to utilize the back arrow 140 and the forward arrow 150, the user can actuate one or more hard or soft keys functionally represented by the back and forward arrows 140 and 150, respectively, on a mobile device (not shown) in which the small screen display 100 is implemented. Alternatively, a physical cursor key, rocker key, or other suitable actuatable device(s) can be utilized to provide instructions to the mobile device to scroll through displayed web pages that the user can move backward and forward to. For example, a trackball or mouse can be utilized to direct a cursor shown on the small screen display 100 to effectuate navigation. Although FIG. 5A represents the possible backwards and forwards movement with horizontally-oriented scrolling, it should be understood that the previously viewed web pages can be oriented vertically, diagonally, or in any other convenient orientation, and directional arrows can be displayed in accordance with the desired orientation(s).

It should be noted that multiple orientations can also be implemented on the small screen display 100, e.g., a combination of horizontal, vertical, and diagonal orientations, where for example, previously viewed web pages can be represented by thumbnails organized in a grid-like display or barrel/fish-eye-like view. Furthermore, in addition to arrows, other possible indicators include, but are not limited to, scrollbars and descriptive text, e.g., the text “forward” and “back” can be displayed on the small screen display 100 in lieu of the back and forward arrows 150 and 140, respectively. Yet another alternative can be to forego any sort of directional indicator, allowing the user to intuitively utilize, for example, the above-described keys to move about the web pages.

According to another embodiment of the present invention, the mobile device can employ a touch screen where actions associated with the small screen display 100 can be controlled by the user tapping or otherwise touching the touch screen. For example, the user can use a stylus to tap either the back arrow 140 or the forward arrow 150 to move backward to or forward to a desired web page, respectively. In addition, if as described above, the available web pages for viewing are displayed as a grid, the user can simply touch or tap the desired web page to select that web page.

Being that the current thumbnail 120 represents the desired web page for viewing, a portion box 160 is also displayed therein. According to one aspect of the various embodiments of the present invention, a portion box 160 is represented on the small screen display 100 by a visual box, the content of the web page encompassed therein, identifying the portion of the web page that the user desires to see first upon loading or re-loading of the desired web page. The portion box 160 can be selected to be displayed by default as soon as the desired web page is selected by the user. The portion box 160 can be positioned in a substantially central area of the desired web page, a top left or right corner of the desired web page or any convenient default position, or can be positioned at a portion of the desired web page that was last viewed by the user. The user can then change the position of the portion box 160 to encompass the desired portion of the web page if need be. Alternatively, the user can be allowed to set the desired default location of the portion box 160 when it initially appears to the user in, for example, a settings or provisioning feature and/or screen. In addition, the default positioning of the portion box 160 can be controlled by predictive intelligence that places the portion box 160 to encompass a portion of the desired web page that the user is likely to select. For example, the predictive intelligence could be utilized to detect advertising frames in a selected web page and to position the portion box 160 at text that is not included in the advertising frames. The portion box 160 can also be positioned to focus on other types of content including, but not limited to, multimedia content, e.g., video content, graphical content, sound content, etc., web syndication feed, e.g, RSS feeds, podcasts, weblogs, news feeds, etc., and input fields, such as search fields, login fields, etc. It should be noted that instead of utilizing predictive intelligence or pre-configured preferences set by the user, a dedicated shortcut key, a softkey, and/or other appropriate controls can be configured to focus on content upon prompting by the user.

When the focused content can be reconfigured or rendered, such as for example, with textual content, the various embodiments of the present invention can also be configured to perform such rendering. As noted above, the focused content can include, but is not limited to, multimedia content, e.g., video content, graphical content, sound content, etc., web syndication feed, e.g, RSS feeds, podcasts, weblogs, news feeds, etc., and input fields, such as search fields, login fields, etc., where various types or method of rendering can be performed thereon. If a user positions the portion box 160 generally about a portion of text in a web page, the text is rendered to fit within small screen display 100 regardless of how the text is to be displayed according to the original formatting of the web page. If the user navigates the text and/or the web page so that the text is no longer centrally focused upon within the small screen display 100, the user can actuate a softkey or a hardkey, dedicated or otherwise, or some other appropriate control, e.g., voice control, touch, etc., to re-center the text. Alternatively, the softkey, hardkey, or other control can be initially actuated by the user to focus on the text or other type of content to be focused upon. In another embodiment of the present invention, the rendering and centering text or other content to be focused on can be initiated upon the user first sending a command or instruction to begin browsing the web page. For example, the first navigation command given by the user, e.g., to scroll up within the web page, the text to be focused on is rendered and centered. Thereafter, the user can scroll and/or navigate throughout the web page in a conventional manner.

Although the portion box 160 is visually represented as an actual box, alternative indications can be utilized. For example, the portion box 160 need not be square in shape, but can also be vertically or horizontally rectangular. Shapes such as circles, triangles, etc. can be utilized to indicate a desired display area of the web page. Furthermore, instead of or in addition to displaying an outlined shape, a frameless region can be highlighted, underlined, or otherwise differentiated to indicate a desired portion of the web page. For example, the portion box 160 can be displayed as a transparent area.

Alternatively, a visual marker can be utilized, e.g., a dot or cross hairs, that can be moved to a general area substantially about the desired portion of the web page. Predictive intelligence can then be utilized to determine a region of focus within that general area. For example, the predictive intelligence can be instructed or configured to focus on text and/or figures as described above. It should be noted that even if the user chooses to navigate the portion box 160 to a particular portion of the web page, the focus can be changed and/or adjusted to focus on content or an object of interest near to the area encompassed by the portion box 160 or near the area generally indicated by the visual marker.

It should also be noted that the portion box 160 can be displayed in an “overview” mode, as for example, when web page is being displayed in accordance with the user actuating the back arrow 140 and/or the forward arrow 150. In addition, the portion box 160 can be displayed and used to navigate a pop-up “minimap” that can appear when scrolling through a web page. Moreover, when in the overview mode, a “reset” feature can be effectuated to allow the portion box 160 to be re-located to a default or other appropriate position. For example, if the user determines that if portion of a web page encompassed by the portion box 160 is not what the user desired, the portion box can be easily re-located to an appropriate position.

The portion box 160 can be moved to any portion of the moved back to or moved forward to web page. Movement of the portion box 160 can be accomplished by the user actuating the same hard or soft keys, cursor key, rocker key, etc. after the desired web page to be moved back to or forward to has been selected as described above. Alternatively, a trackball, a joystick, keys, or sets of keys that are different from those used to scroll through the possible web pages for viewing can be used to direct movement of the portion box 160. Like the movement described above regarding the scrolling of the web pages, the portion box 160 can be moved vertically, horizontally, diagonally, or in any other appropriate direction(s) suitable for navigating the current thumbnail 120. It should be understood that in order to allow the user to choose a specific portion of the current thumbnail 120 for display, a greater range of movement and/or directions can be provided when moving the portion box 160 than when scrolling through available web pages. When a touch screen device is utilized, the user can utilize a stylus or his or her finger to select the portion box 160 and drag the portion box 160 to a desired portion of the web page indicated in the current thumbnail 120. Furthermore, when the portion box 160 is at a web page border, e.g., the furthest right-hand side or left-hand side of the web page, the user can effectuate moving to a previous or subsequent web page automatically by tapping, double-clicking, or invoking some different actuating action. In other words, the user is not required to back out of a current mode, e.g., browsing a current web page preview to jump to another web page.

In addition, depending on the accuracy desired during movement of the portion box 160, different and/or dynamic “granularity” levels can be specified in accordance with the various embodiments of the present invention. For example, when a web page to be moved backwards or forwards to comprises a large amount of small text, high granularity can be specified so that the user can accurately select a desired portion of the text for display upon loading or re-loading of the desired web page. Alternatively, the portion box 160 can utilize lower granularity levels when the desired web page contains larger text or graphical content.

Moreover, although the portion box 160 can initially be displayed with a default size, the portion box 160 itself can be dynamically implemented so as to adapt to, for example, different portions of the web page, e.g., when frames, tables, table cells, or other blocks or similar elements, if present, are detected. That is, when the user moves the portion box 160 to a specific frame within the web page, the portion box can contract or expand depending on the size of the specific frame. The amount of expansion can be limited depending, for example, on the size of the small screen display 100 so that the user does not choose to display a portion of a web page so large that there is no advantage to focusing on a specific portion of the web page. In addition, if one or more parts of the specific portion of the desired web page to be focused on does not contain content, viewable or otherwise, such parts can be ignored, thus leaving more space for those parts containing actual content.

When a selected portion of a web page moved back to or forward to, is smaller than an a total displayable area of the small screen display 100, that selected portion encapsulated by the portion box 160 can be zoomed in on or magnified upon loading or re-loading of the web page. Alternatively, content outside of the portion box 160, such as the content that borders the four sides of the portion box can also be displayed on the small screen display 100. This allows the user to gain a certain amount of context relevant to the chosen content of the web page selected for display. In addition, the user can be allowed to select multiple desired portions of the web page to be initially displayed in the same small screen display 100 view, or the multiple desired portions of the web page can be displayed in sequential or any other sorted or random order, or as separate pages. That is, each one of the multiple desired portions of the web page can be treated, for display purposes, as its own web page.

It should be noted that whatever form of movement and/or selection is utilized with the various embodiments of the present invention, the user will not sense any discontinuity between movement and/or selection methods employed, for example, when the user is browsing current web page content. That is, for instance, no new layers of navigation need to be added in order to implement the various embodiments of the present invention. Instead, previously defined methods of navigation can be called when the user is moving the portion box 160 and/or scrolling through available web pages. Alternatively, the methods of movement and selection described herein can also be implemented as navigation methods for use with standard web page navigation, apart from merely those features of selecting a web page to move backward or forward to and movement of the portion box 160. Furthermore, the features provided by the various embodiments of the present application can be activated or deactivated according to the needs of the user. For example, a settings menu can incorporate one or more provisioning options related to the features described herein. Alternatively, the features described herein can be set to automatically execute, for example, when web pages to be viewed are determined to be unviewable in their entirety at any one given time within the small screen display 100.

Once the selected portion of the desired web page, indicated by the portion box 160, is displayed, the user is thereafter able to view the remaining portion of the desired webpage through the use of the movement features/functionality discussed above, e.g., scrolling. Alternatively, the various embodiments of the present invention can be limited to showing only the portion of the desired web page selected using the portion box 160.

FIG. 5B shows another aspect of the various embodiments of the present invention, where the user himself or herself is allowed to draw the portion box 160. For example, when the small screen display 100 is implemented on a touch screen, the user can use a stylus to literally draw a box around the desired portion of the web page on the current thumbnail 120. This can be accomplished by allowing the user to drag his or her stylus substantially about a desired portion of the web page to be displayed. It should be noted that in FIG. 5B, only a part of the portion box 160 is shown because the portion box 160 has reached a border of the current thumbnail 120. However, in another embodiment of the present invention, the current thumbnail 120 can be scrolled to reveal remaining portions of the web page previewed in the current thumbnail 120 when a border is reached by the portion box 160. That is, the user is able to navigate the entire web page previewed within the current thumbnail 120.

In addition, drawing the portion box 160 can include enclosing and/or highlighting, for example, text. Therefore, only the enclosed and/or highlighted text will initially be displayed to the user. Thus, in one embodiment, the formatting of the enclosed and/or highlighted text according to the web page can be adjusted so that the selected text is displayable on the small screen display 100. As described above, navigating and/or viewing remaining portions of the web page is possible after the initial display of content, i.e., the enclosed and/or highlighted text. Alternatively, unlike the embodiments of the present invention described above where the portion box 160 is immediately displayed upon selection of the desired web page, the user can be allowed to tap on a general area about which the portion box 160 is to be drawn. Once the general area is selected, the portion box 160 is drawn by using a stylus, for example, to drag a framed outline of the portion box out from the selected general area. In addition, the various embodiments of the present invention can automatically “guess” or estimate where the general area about which the portion box 160 is to be drawn. Such a feature can be accomplished, for example, by analyzing elements including, but not limited to borders, frames, changes in color, pictures, table cells, certain text, horizontal lines (i.e., “hlines”), and vertical lines (i.e., “vlines”).

As described above, the user can be allowed to draw one or more portion boxes 160 to be initially displayed in the same small screen display 100 view, or the multiple desired portions of the web page can be displayed in sequential or any other sorted or random order, or as separate pages. That is, each one of the multiple desired portions of the web page can be treated, for display purposes, as its own web page, where a new window is opened for each portion box 160 drawn that at least initially focuses on the desired portion enclosed within the drawn portion box 160. Alternatively, the new windows can be merged/assembled in some format for displaying as a single and/or full page. It should be noted that other and/or additional methods of indicating and/or drawing the portion box 160 can be realized by the various embodiments of the present invention.

When the small screen display 100 is implemented as a touch screen, for example, as described above, where the user is able to draw his or her own portion box 160, according to another embodiment of the present invention, the user can be allowed to draw the portion box 160 so that the desired portion of the selected web page is still larger than what the small screen display 100 is capable of displaying at any one time, though still smaller than the entire web page. In such a case, a default portion of the desired web page can be initially displayed to the user. For example, a top left corner of the desired portion of the selected web page can initially be displayed to the user, where the user can then scroll and/or otherwise navigate In addition, the user can be allowed to select multiple desired portions of the web page to be initially displayed in the same small the desired portion of the selected web page. Alternatively, the portion box 160 can be drawn around a selected portion of an overview or a minimap display. According to such a feature, the user can utilize a stylus or other pointing device that was used to draw the portion 160 and move the portion box 160 to various locations on the overview or minimap. This can be done instead of drawing a new portion box 160 that could potentially have an un-useful zoom level, as for example, if the user selects a desired portion of the overview or minimap that is too small or too large.

FIG. 5C shows another embodiment of the present invention, where either before, after, or substantially at the same time navigation within the current thumbnail 120 is invoked, a second set of navigation keys 170 is displayed in the small screen display 100. In this way, a user is able to more easily differentiate between the backward and forward arrows 140 and 150, respectively, and the navigation controls represented by the navigation keys 170 for navigating within the current thumbnail 120. Alternatively, a toggle control can be represented by a text, “Toggle” 180, that allows the user to toggle between backward and forward arrows 140 and 150, and the navigation keys 170. This can be utilized, for example, if the navigation keys 170 are to always be displayed in the small screen display 100 along with the backward and forward arrows 140 and 150. Alternatively, toggling can be accomplished by a “long” press or double clicking/pressing of one of the backward and forward arrows 140 and 150 and the navigation keys 170 (in the case of a touch screen) or a key representative thereof. As described above, it is possible for the user to perform some actuating action to jump to a previous or subsequent web page while the portion box 160 is in use. In accordance with this embodiment then, navigation keys 170 and/or toggle key 180 can be utilized to continue controlling movement of the portion box 160 in the previous or subsequent web page without having to first utilize backward and forward arrows 140 and 150 to first select the previous or subsequent web pages 110 and 130.

It should be noted that, as described above, various hard and/or soft keys, sets of keys, and other physical control members can be assigned to operate with the backward and forward arrows 140 and 150 as well as with the navigation keys 170. For example, a set of soft keys can be used to select either the backward arrow 140, any of the navigation keys 170, and the forward arrow 150. Upon the user deciding on a particular instruction, the user can actuate a “select” key (not shown) to finalize his or her choice. In addition, a select key can be utilized in the various embodiments described above to indicate that the portion box 160 is encompassing a desired portion of the web page previewed in the current thumbnail 120. Upon actuation of the select key, the desired portion is initially displayed on the small screen display 100. Alternatively, the user can actuate a set of keys in accordance with the backward and forward arrows 140 and 150 and, upon reaching a desired web page represented by the current thumbnail 120, the user can actuate a select key to select the desired web page. The user can then actuate the same set of keys or different keys in accordance with the navigations keys 170, and upon settling on a desired portion of the desired web page, can again actuate the select key to select the desired portion.

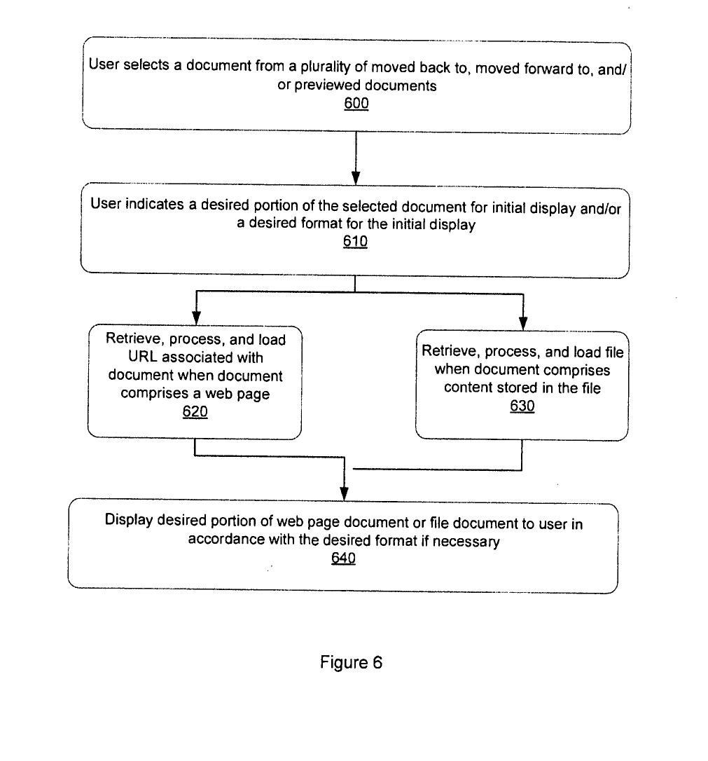

FIG. 6 shows a flow chart illustrating exemplary operations executed in accordance with the various embodiments of the present invention. During a document browsing session, a user can view and/or re-view a plurality of documents, thus creating a viewed document history or a preview format of one or more documents. The user can navigate among/through the plurality of viewed documents using, for example, the back arrow 140 and the forward arrow 150, described above in a mobile browser within which, or operating in conjunction with the various embodiments of the present invention. At 600, the user can select a document from the plurality of documents in the viewed document history or the one or more documents presented in preview form. Once the user has selected a document, at 610, the user can indicate a desired portion of the selected document for initial display in the mobile browser. In addition, the user and/or the mobile browser can specify a desired format for displaying the desired portion of the selected document. If the document comprises a web page, for example, a URL associated with the web page is retrieved, processed if for example, textual content needs to be rendered or reformatted, and loaded into the mobile browser at 620. If the document comprises content stored in a file, for example, the file is retrieved, processed, and loaded into the mobile browser at 630. At 640, the desired portion of the selected document is displayed to the user within the mobile browser in accordance with the desired format, if such a format was indicated.

It should be noted that the various embodiments of the present invention are discussed herein in relation to Internet web pages and mobile browsers. However, it should be understood that the various embodiments of the present invention can be applied to virtually any type of document or content that is not capable of being displayed in its entirety on a display and to any application or function capable of displaying documents. For example, a text document can be loaded or re-loaded by accessing and processing at least one file wherein the document is stored. In addition, the display is not limited to that implemented on a mobile device, but to any display which cannot display content in its entirety. Conventional web browsers implemented on full-size displays associated with laptop or desktop computers can also utilize the features of the various embodiments of the present invention described herein. For example, when viewing interactive maps that allow focused viewing of portions of the interactive map, but do not maintain points of interest when navigating to other portions, a point of interest can be maintained and/or re-highlighted/re-focused on when the navigating returns to an area near the point of interest.

It should also be noted that the thumbnail views described above need not only display previously viewed, hyperlinked, or to-be-viewed web pages. For example, a web page that is currently being viewed can be zoomed out to a thumbnail view, thus allowing the user to utilize the portion box 160 described above to select a new area of the currently viewed web page for display. In addition, instead of immediately displaying a desired portion of the selected document upon identification of the desired portion, other functions and/or actions could be undertaken. For example, the user could indicate that he or she wants to print, bookmark, save, forward via e-mail, short message service (SMS), instant messaging, etc., the desired portion of the document indicated by the portion box 160.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of selectively displaying content, comprising:
selecting a document, the document comprising at least one of a moved back to document, a moved forward to document, and a previewed document, the content of which cannot be displayed in its entirety at a single given moment;
indicating at least one desired portion of the document that is to be first displayed on the display; and
displaying the desired portion of the document on the display upon loading the document.

2. The method of claim 1 further comprising, navigating among a plurality of at least one of either moved back to documents, moved forward to documents, and previewed documents.

3. The method of claim 1, wherein the document comprises a web page.

4. The method of claim 3, wherein the loading of the document comprises accessing and processing a uniform resource locator associated with the document for displaying the document in a mobile browser application display.

5. The method of claim 3, wherein the loading of the document comprises re-loading a uniform resource locator of a previously visited web page.

6. The method of claim 1, wherein the document includes displayable content.

7. The method of claim 6, wherein the loading of the document comprises retrieving a file in which the document is stored, opening the file, and retrieving the displayable content for display in a mobile browser application display.

8. The method of claim 1, wherein the indicating of the at least one desired portion of the document comprises:
navigating within a thumbnail representation of the document utilizing at least one of a graphical and a regional indicator; and
positioning the at least one of the graphical indicator and the regional indicator so that the at least one desired portion of the document is substantially encompassed by the at least one of the graphical indicator and the regional indicator.

9. The method of claim 8, wherein if the at least one desired portion of the document substantially encompassed by the graphical indicator does not substantially fill the display, displaying additional content substantially surrounding the at least one desired portion of the document.

10. The method of claim 8, wherein if the at least one desired portion of the document substantially encompassed by the graphical indicator does not substantially fill the display, magnifying the at least one desired portion of the document to substantially fill the display.

11. The method of claim 8, wherein a default position of the at least one of the graphical and regional indicators substantially encompasses a latest viewed portion of the document, and wherein a user can re-position the at least one of the graphical and regional indicators to substantially encompass the at least one desired portion of the document.

12. The method of claim 8, wherein the at least one of the graphical and the regional indicators are dynamically adjustable with regard to at least one of a size component and an accuracy component.

13. The method of claim 1, wherein the indicating of the at least one desired portion of the document comprises:
navigating within a thumbnail representation of the document utilizing at least one of a graphical and a regional indicator; and
automatically positioning the at least one of the graphical indicator and the regional indicator so that the at least one desired portion of the document is within a predetermined proximity to the at least one of the graphical indicator and the regional indicator.

14. The method of claim 1, wherein the indicating of the at least one desired portion of the document comprises:
choosing a general area of a thumbnail representation of the document substantially proximate to the at least one desired portion of the document; and
drawing a graphical indicator substantially about the general area and substantially encompassing the at least one desired portion of the document.

15. The method of claim 14, wherein the display comprises a touch screen display.

16. The method of claim 1, further comprising displaying the at least one desired portion of the document in accordance with a desired formatting scheme, wherein the desired formatting scheme includes at least one of centering and re-centering content contained within the desired portion of the document.

17. The method of claim 16, wherein the content includes at least a web syndication feed, a multimedia object, and an input field.

18. An apparatus, comprising:
a processor unit; and
a memory unit operatively connected to the processing unit and including:
computer code for selecting a document, the document comprising at least one of a moved back to document, a moved forward to document, and a previewed document, the content of which cannot be displayed in its entirety at a single given moment;
computer code for indicating at least one desired portion of the document that is to be first displayed on the display; and
computer code for displaying the at least one desired portion of the document on the display upon loading the document

19. The apparatus of claim 18, wherein the memory unit further comprises computer code for navigating among a plurality of at least one of either moved back to documents, moved forward to documents, and previewed documents.

20. The apparatus of claim 18 wherein the document comprises a web page.

21. The apparatus of claim 20, wherein the computer code for loading the document includes computer code for accessing and processing a uniform resource locator associated with the document for displaying the document in a mobile browser application display.

22. The apparatus of claim 20, wherein the computer code for loading the document includes computer code for re-loading a uniform resource locator of a previously visited web page

23. The apparatus of claim 18, wherein the document includes displayable content.

24. The apparatus of claim 23, wherein the computer code for loading the document includes computer code for retrieving a file in which the document is stored, opening the file, and retrieving the displayable content for display in a mobile browser application display.

25. The apparatus of claim 18, wherein the computer code for indicating the at least one desired portion of the document includes computer code for:
navigating within a thumbnail representation of the document utilizing at least one of a graphical and a regional indicator; and
positioning the at least one of the graphical indicator and the regional indicator so that the at least one desired portion of the document is substantially encompassed by the at least one of the graphical indicator and the regional indicator.

26. The apparatus of claim 25, wherein the memory unit further comprises computer code for displaying additional content substantially surrounding the at least one desired portion of the document upon a determination that the at least one desired portion of the document substantially encompassed by the graphical indicator does not substantially fill the display.

27. The apparatus of claim 25, wherein a default position of the at least one of the graphical and regional indicators substantially encompasses a latest viewed portion of the document, and wherein the memory unit further comprises computer code for allowing a user to re-position the at least one of the graphical and regional indicators to substantially encompass the at least one desired portion of the document.

28. The apparatus of claim 25, wherein the memory unit further comprises computer code for magnifying the at least one desired portion of the document to substantially fill the display upon a determination that the at least one desired portion of the document substantially encompassed by the graphical indicator does not substantially fill the display.

29. The apparatus of claim 25, wherein the at least one of the graphical and the regional indicators are dynamically adjustable with regard to at least one of a size component and an accuracy component.

30. The apparatus of claim 18, wherein the computer code for indicating the at least one desired portion of the document includes computer code for:
navigating within a thumbnail representation of the document utilizing at least one of a graphical and a regional indicator; and
automatically positioning the at least one of the graphical indicator and the regional indicator so that the at least one desired portion of the document is within a predetermined proximity to the at least one of the graphical indicator and the regional indicator.

31. The apparatus of claim 18, wherein the computer code for indicating the at least one desired portion of the document includes computer code for:
choosing a general area of a thumbnail representation of the document substantially proximate to the at least one desired portion of the document; and
drawing a graphical indicator substantially about the general area and substantially encompassing the at least one desired portion of the document.

32. The apparatus of claim 31, wherein the display comprises a touch screen display.

33. The apparatus of claim 18 wherein the memory unit further comprises computer code for displaying the at least one desired portion of the document in accordance with a desired formatting scheme, and wherein the desired formatting scheme includes at least one of centering and re-centering content contained within the desired portion of the document.

34. The apparatus of claim 33, wherein the content includes at least a web syndication feed, a multimedia object, and an input field.

35. A computer program product for selectively displaying content, embodied on a computer-readable medium, comprising:
computer code for selecting a document, the document comprising at least one of a moved back to document, a moved forward to document, and a to-be-viewed document, the content of which cannot be displayed in its entirety at a single given moment;
computer code for indicating at least one desired portion of the document that is to be first displayed on the display; and
computer code for displaying the at least one desired portion of the document on the display upon loading the document.

36. The computer program product of claim 35, wherein the computer code for indicating the desired portion of the document includes computer code for:
navigating within a thumbnail representation of the document utilizing at least one of a graphical and a regional indicator; and
positioning the at least one of the graphical indicator and the regional indicator so that the at least one desired portion of the document is substantially encompassed by the at least one of the graphical indicator and the regional indicator.

37. A device, comprising:
a memory unit;
a processor unit operatively connected to the memory unit; and
small screen display unit for displaying web content;
wherein the memory unit includes a computer program product, including:
computer code for displaying a plurality of thumbnail representations of web pages previously visited by a user;
computer code for allowing the user to visually navigate through the thumbnail representations;
computer code for further allowing the user to select one of the plurality of thumbnail representations;
computer code for graphically indicating at least one desired portion of a web page represented by the thumbnail representation, wherein the computer code for the indicating of the desired portion includes computer code for allowing the user to position a graphical indicator so that the at least one desired portion is substantially encompassed by the graphical indicator;
computer code for re-loading the web page represented by the thumbnail representation for display; and
computer code for initially displaying only the at least one desired portion of the web page upon re-loading.

38. The device of claim 39, wherein the memory unit further comprises computer code for at least one of saving the at least one desired portion of the web page, printing the at least one desired portion of the web page, and forwarding the at least one desired portion of the web page via a messaging function of the device.

39. An apparatus, comprising:
display means;
at least one actuating means for controlling content to be displayed on the display means and including:
selecting means configured to operate in accordance with the at least one actuating means for selecting a document, the document comprising at least one of a moved back to document, a moved forward to document, and a previewed document, the content of which cannot be displayed in its entirety at a single given moment;
indicating means configured to operate in accordance with the at least one actuating means for indicating at least one desired portion of the document that is to be first displayed on the display; and
portion display means for displaying the at least one desired portion of the document on the display upon loading the document. The apparatus of claim 43, wherein the indicating means comprises:
navigation means for navigating within a thumbnail representation of the document utilizing at least one of a graphical and a regional indicator; and
positioning means for positioning the at least one of the graphical indicator and the regional indicator so that the at least one desired portion of the document is substantially encompassed by the at least one of the graphical indicator and the regional indicator.
